(19) United States
(12) Patent Application Publication
(10) Pub. No.: US 2026/0197491 A1
(43) Pub. Date: Jul. 9, 2026

(54) METHOD AND APPARATUS FOR VIDEO CODING USING ADAPTIVE REFERENCE LINE CANDIDATE LIST

(71) Applicants: Hyundai Motor Company, Seoul (KR); Kia Corporation, Seoul (KR); RESEARCH & BUSINESS FOUNDATION SUNGKYUNKWAN UNIVERSITY, Suwon-si, Gyeonggi-do (KR)

(72) Inventors: Byeung Woo JEON, Seongnam-si, Gyeonggi-do (KR); Yu Jin LEE, Suwon-si Gyeonggi-do (KR); Jee Yoon PARK, Seoul (KR); Jin HEO, Yongin-si Gyeonggi-do (KR); Seung Wook PARK, Yongin-si Gyeonggi-do (KR)

(73) Assignees: Hyundai Motor Company, Seoul (KR); Kia Corporation, Seoul (KR); RESEARCH & BUSINESS FOUNDATION SUNGKYUNKWAN UNIVERSITY, Suwon-si, Gyeonggi-do (KR)

(21) Appl. No.: 19/132,217

(22) PCT Filed: Nov. 17, 2023
(86) PCT No.: PCT/KR2023/018591

§ 371 Date: May 22, 2025

(30) Foreign Application Priority Data
Dec. 20, 2022 (KR) 10-2022-0179526
Nov. 16, 2023 (KR) 10-2023-0159458

(51) Int. Cl. H04N 19/593; H04N 19/105; H04N 19/176

(52) U.S. Cl. CPC H04N 19/593; H04N 19/105; H04N 19/176

(57) ABSTRACT

A method and an apparatus are disclosed for a video coding using an adaptive reference line candidate list. In the disclosed embodiments, a video decoding device decodes, from a bitstream, an intra-prediction mode of the current block and a multiple reference line index (MRL index). The video decoding device obtains a length of the MRL candidate list that indicates a number of reference lines included in the MRL candidate list, and obtains at least one or more filling methods. The video decoding device generates the MRL candidate list by adding reference lines corresponding to the length of the MRL candidate list to the MRL candidate list by using the at least one or more filling methods. The video decoding device derives the reference line from the MRL candidate list by using the MRL index, and generates, by using the reference line, a prediction block of the current block according to the intra-prediction mode.

### TECHNICAL FIELD

The present disclosure relates to a video coding method and an apparatus using an adaptive reference line candidate list.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Intra-prediction utilizes information on the pixels within the common picture to predict pixel values for the current block to be encoded. The intra-prediction may select one of multiple intra-prediction modes that best fits the features of the picture, and use the selected intra-prediction mode for prediction of the current block. An encoder selects one of the multiple intra-prediction modes and encodes the current block by using the selected mode. The encoder may then pass information on the mode to a decoder.

HEVC technology utilizes a total of 35 intra-prediction modes for intra prediction, including 33 angular modes with directionality and 2 non-angular modes without directionality. However, as the spatial resolution of videos increases from 720×480 to 2048×1024 or 8192×4096, the unit size of the prediction block is accordingly increasing, which requires the addition of more diverse intra-prediction modes. As illustrated in FIG. 3A, the VVC technique utilizes further subdivided 65 prediction modes for intra prediction, which allows for a greater diversity of prediction directions compared to previous techniques.

Meanwhile, when performing intra prediction, since the prediction block is generated by using the pixels around the current block, the performance of intra prediction depends on the selection of appropriate reference pixels. As a method of selecting reference pixels, one can use a method of obtaining reference pixels from a more accurate direction by securing a diversity of prediction modes or a method of increasing the number of usable reference pixel candidates. Prior art techniques corresponding to the latter are referred to as Multiple Reference Line (MRL) or Multiple Reference Line Prediction (MRLP). For example, when employing MRL for intra prediction of the current block, further distant pixels may be used for prediction as reference pixels in addition to the reference line immediately adjacent to the current block at one-pixel interval.

In conventional MRL techniques, the MRL candidate list, which lists reference lines that are referenceable, is carelessly applied to all blocks equally. Therefore, there is a need for a method of improving MRL techniques to increase video coding efficiency and enhance video quality.

### DISCLOSURE

### Technical Problem

The present disclosure seeks to provide a video coding method and an apparatus for an MRL technique of intra prediction, which adaptively determine an MRL candidate list-filling method and the number of reference lines included in the MRL candidate list.

### Technical Solution

At least one aspect of the present disclosure provides a method of reconstructing a current block by a video decoding apparatus. The method includes decoding, from a bitstream, an intra-prediction mode of the current block and a multiple reference line index (MRL index) that indicates, from within an MRL candidate list, a reference line to be used for intra prediction of the current block. The method also includes obtaining a length of the MRL candidate list that indicates a number of reference lines included in the MRL candidate list. The method also includes obtaining at least one or more filling methods. The method also includes generating the MRL candidate list by adding reference lines corresponding to the length of the MRL candidate list to the MRL candidate list by using the at least one or more filling methods. The method also includes deriving the reference line from the MRL candidate list by using the MRL index. The method also includes generating, by using the reference line, a prediction block of the current block according to the intra-prediction mode.

Another aspect of the present disclosure provides a method of encoding a current block by a video encoding apparatus. The method includes determining an intra-prediction mode of the current block and a multiple reference line index (MRL index) that indicates, from within an MRL candidate list, a reference line to be used for intra prediction of the current block. The method also includes obtaining a length of the MRL candidate list that indicates a number of reference lines included in the MRL candidate list. The method also includes obtaining at least one or more filling methods. The method also includes generating the MRL candidate list by adding reference lines corresponding to the length of the MRL candidate list to the MRL candidate list by using the at least one or more filling methods. The method also includes deriving the reference line from the MRL candidate list by using the MRL index. The method also includes generating, by using the reference line, a prediction block of the current block according to the intra-prediction mode.

Yet another aspect of the present disclosure provides a computer-readable recording medium storing a bitstream generated by a video encoding method. The video encoding method includes determining an intra-prediction mode of a current block and a multiple reference line index (MRL index) that indicates, from within an MRL candidate list, a reference line to be used for intra prediction of the current block. The video encoding method also includes obtaining a length of the MRL candidate list that indicates a number of reference lines included in the MRL candidate list. The video encoding method also includes obtaining at least one or more filling methods. The video encoding method also includes generating the MRL candidate list by adding reference lines corresponding to the length of the MRL candidate list to the MRL candidate list by using the at least one or more filling methods. The video encoding method also includes deriving the reference line from the MRL candidate list by using the MRL index. The video encoding method also includes generating, by using the reference line, a prediction block of the current block according to the intra-prediction mode.

### Advantageous Effects

As described above, the present disclosure provides a video coding method and an apparatus for refining a motion vector at the decoder side by using an intra predictor generated by intra-predicting the current block or by using a ratio of the magnitudes of two motion vectors in a uni-directional prediction using one reference picture or a bi-prediction with the current picture being temporally deviated from the center of the two reference pictures. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating a reference line utilized by multiple reference lines (MRL).

FIG. 7 is another illustrative diagram of reference lines utilized by MRL.

FIG. 8 is a diagram illustrating an MRL candidate list-filling method, according to at least one embodiment of the present disclosure.

FIG. 9 is a diagram illustrating an MRL candidate list-filling method, according to another embodiment of the present disclosure.

FIG. 10 is a diagram illustrating an MRL candidate list-filling method, according to another embodiment of the present disclosure.

FIG. 11 is a diagram illustrating reference lines of neighbor blocks of the current block, according to at least one embodiment of the present disclosure.

FIG. 12 is a diagram illustrating the position of a current block in a coding tree unit (CTU), according to at least one embodiment of the present disclosure.

FIG. 13 is a diagram illustrating reference lines of previously reconstructed blocks, according to at least one embodiment.

FIGS. 14A and 14B are diagrams illustrating co-located blocks in reference pictures, according to at least one embodiment.

FIG. 15 is a diagram illustrating pixels used to represent neighbor blocks of the current block, according to at least one embodiment.

FIG. 16 is a flowchart of a method of encoding a current block by a video encoding apparatus, according to at least one embodiment of the present disclosure.

FIG. 17 is a flowchart of a method of reconstructing the current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

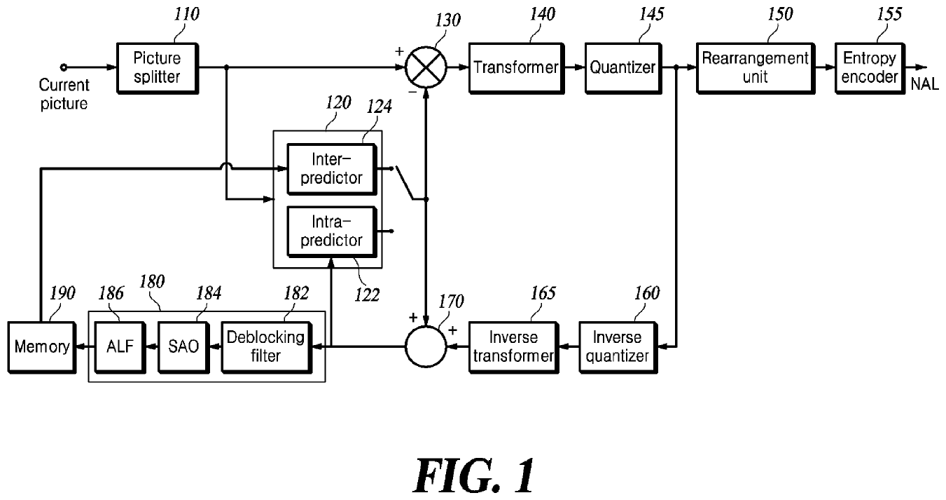

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

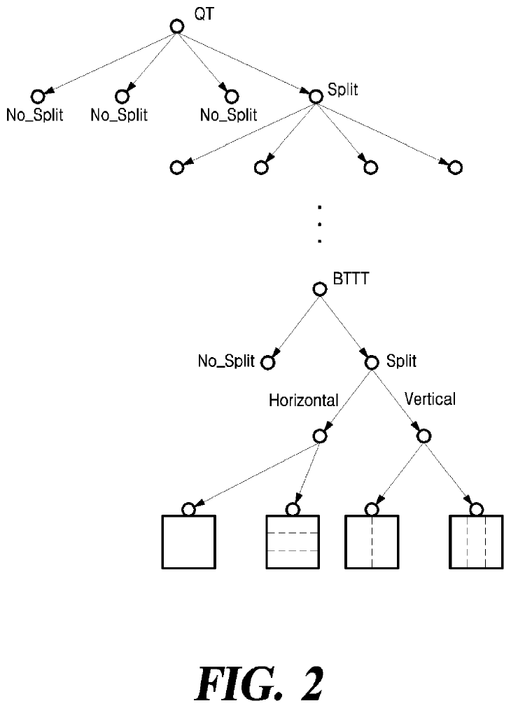

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

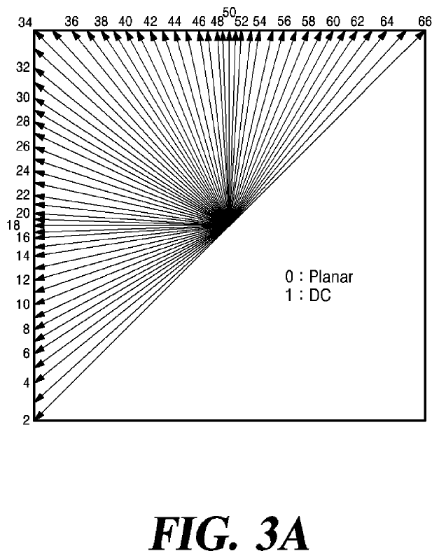

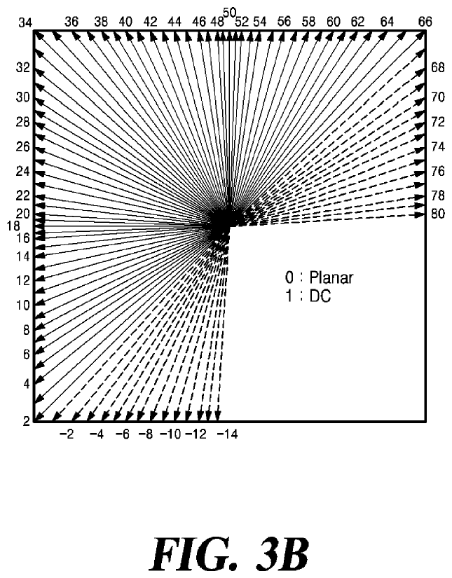

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

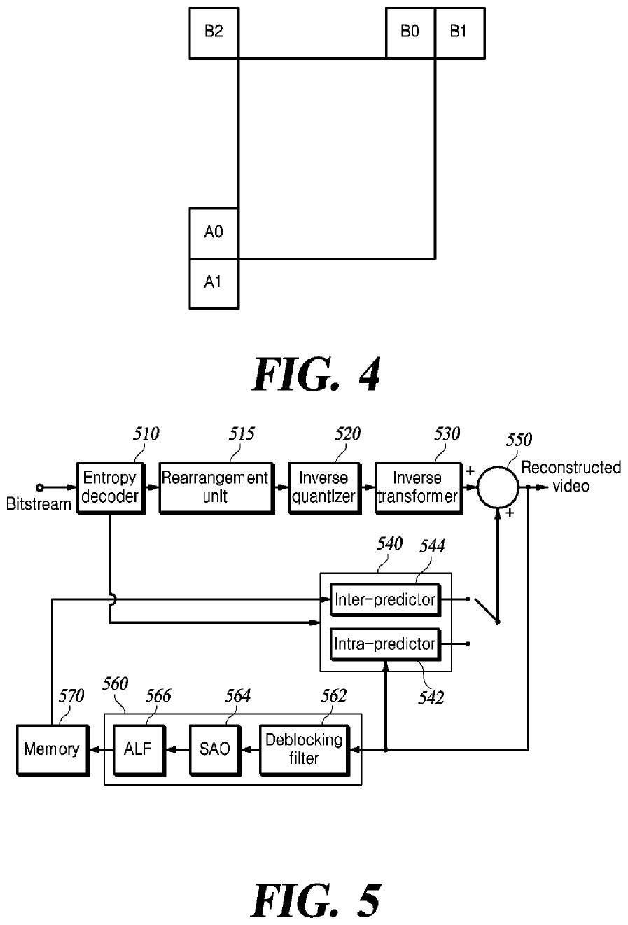

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus applied to multiple reference line (MRL) technologies of intra prediction, which adaptively determine an MRL candidate list-filling method and adaptively determine the number of reference lines included in the MRL candidate list.

The following embodiments may be performed by the intra predictor 122 in the video encoding device. The following embodiments may also be performed by the intra predictor 542 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Multiple Reference Line (MRL)

Several techniques are introduced to improve coding efficiency based on intra prediction. MRL techniques, when predicting the current block according to the intra prediction, may use adjacent pixels that are one pixel apart from the current block and further distant pixels as reference pixels for prediction. At this time, pixels with the same distance from the current block are grouped and named as a reference line. The MRL technique performs intra prediction of the current block by using the pixels on the selected reference line.

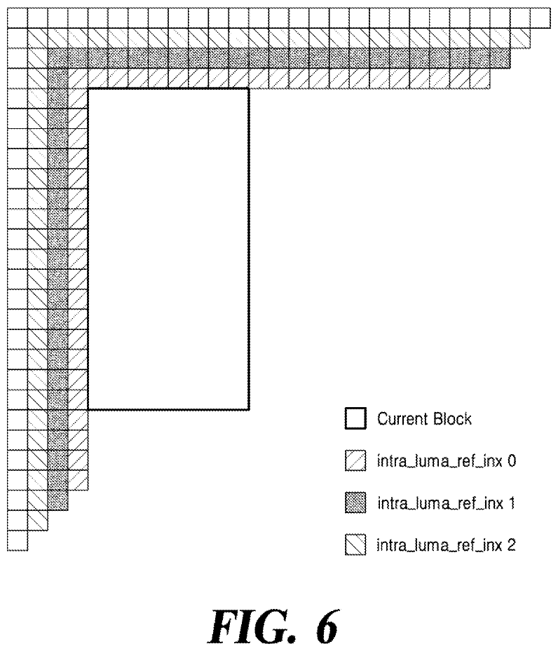

To indicate the reference line to use when performing the intra prediction, the video encoding apparatus signals the reference line index, intra_luma_ref_idx to the video decoding apparatus. In the existing VVC (Versatile Video Coding), the reference line represented by each intra_luma_ref_idx is illustrated in FIG. 6. The existing VVC uses intra_luma_ref_idx to indicate one of the three reference lines that are closest to the current block. The bit allocations to the respective reference line index values are shown in Table 1.

TABLE 1

| intra_luma_ref_idx | Bit allocation |
|---|---|
| 0 | 0 |
| 1 | 10 |
| 2 | 11 |

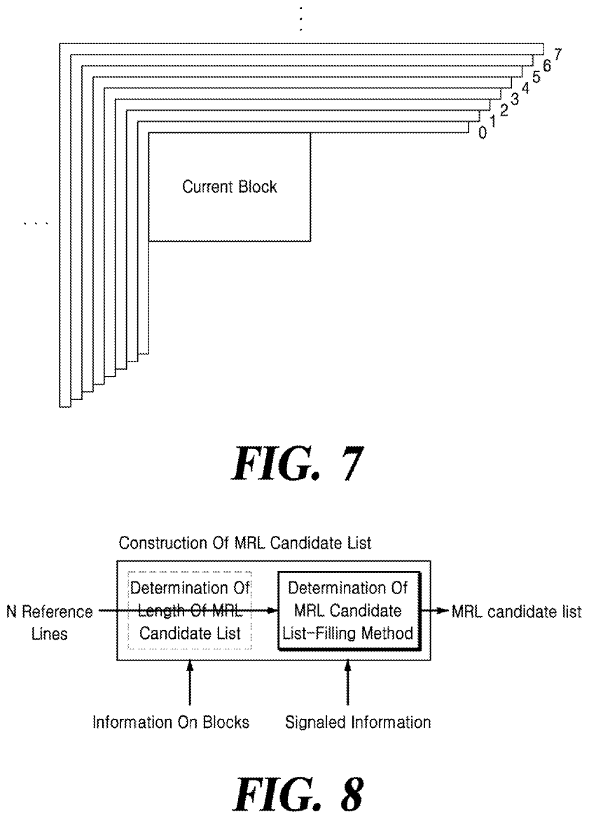

In the Enhanced Compression Model (ECM), a technology beyond VVC, the number of reference lines that are referenceable in the MRL is expanded to six, allowing the use of reference lines with intra_luma_ref_idx values of {0, 1, 3, 5, 7, 12}. In the ECM, the reference lines represented by the respective indices of intra_luma_ref_idx are illustrated in FIG. 7. Furthermore, the bit allocations to the respective reference line index values are shown in Table 2.

TABLE 2

| intra_luma_ref_idx | Bit allocation |
|---|---|
| 0 | 0 |
| 1 | 10 |
| 3 | 110 |
| 5 | 1110 |
| 7 | 11110 |
| 12 | 11111 |

In VVC, since MRL cannot be applied to the block located at the first line in the CTU, the block at that location is always predicted by using intra_luma_ref_idx 0, without parsing information about the reference line. Likewise, in ECM, since MRL cannot be applied to the block located at the first line in the CTU, the block at that location is always predicted by using intra_luma_ref_idx 0, without parsing information about the reference line. Additionally, in ECM, for predicting blocks located outside of the first line within the current CTU, the video encoding apparatus does not test whether or not to use the reference line contained in the top CTU among the reference lines usable for MRL. The video encoding apparatus may signal one of the reference lines tested for use to the video decoding apparatus based on Table 2.

The reference line index, intra_luma_ref_idx, used by the VVC for intra prediction and the syntax for signaling the prediction mode of the current block are shown in Table 3.

```
TABLE 3
} else {
  if( sps_mrl_enabled_flag && ( ( y0 % CtbSizeY ) > 0 ) )
    intra_luma_ref_idx
  if( sps_isp_enabled_flag && intra_luma_ref_idx = = 0 &&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
    intra_subpartitions_mode_flag
  if( intra_subpartitions_mode_flag = = 1 )
    intra_subpartitions_split_flag
  if( intra_luma_ref_idx = = 0 )
    intra_luma_mpm_flag[ x0 ][ y0 ]
  if( intra_luma_mpm_flag[ x0 ][ y0 ] ) {
    if( intra_luma_ref_idx = = 0 )
      intra_luma_not_planar_flag[ x0 ][ y0 ]
    if( intra_luma_not_planar_flag[ x0 ][ y0 ] )
      intra_luma_mpm_idx[ x0 ][ y0 ]
  } else
    intra_luma_mpm_remainder[ x0 ][ y0 ]
}
```

The video decoding apparatus parses intra_luma_ref_idx to determine the reference line index to use for prediction. The Intra Sub-Partitions (ISP) technique is applied when the reference line index is 0, so if the reference line index is non-zero, no information related to ISP is parsed. In addition, MRL is applied when the prediction mode determined by MPM is not planar mode. Therefore, since the reference line index being non-zero indicates the application of MRL, both intra_luma_mpm_flag and intra_luma_not_planar_flag are inferred to be 1.

However, existing MRL techniques suffer from the issue that all blocks receive the same application of the MRL candidate list, which lists reference lines that are referenceable to the MRL. In other words, existing MRL techniques use the same reference lines fixedly.

Since different blocks may have different reference lines that generate better-performing predictors, a block-by-block construction of the MRL candidate list may be feasible by using reference lines that can be selected with higher probability. Therefore, applying the same MRL candidate list to all blocks may not only degrade the prediction performance but also lead to inefficiency in MRL information transmission. Existing MRL techniques are inefficient for using a fixed form of the MRL candidate list without adaptively generating the MRL candidate list by taking into account the information on the current block, the information on neighboring blocks, and the like.

In the following, the predictor and the prediction block are used interchangeably.

The following embodiments are described about the video decoding apparatus, but they may be implemented in the same or similar manner by the video encoding apparatus.

### II. Embodiments According to the Present Disclosure

By adaptively constructing the MRL (Multiple Reference Line) candidate list on a block-by-block basis, the above-described issues of the prior art can be addressed. Accordingly, embodiments according to the present disclosure can be applied to increase video coding efficiency and/or enhance video quality and picture clarity. The video decoding apparatus uses information on blocks and signaled information to determine the length of the MRL candidate list and an MRL candidate list-filling method (or filling method for the MRL candidate list). For example, of N (N≥1) reference lines that are referenceable to the MRL, the video decoding apparatus uses all or some K (K≤N) reference lines to adaptively construct the current block's MRL candidate list. The video decoding apparatus is signaled an MRL index mrl_idx to indicate one reference line to be used for prediction among the reference lines included in the adaptively determined MRL candidate list of each block. The mrl_idx indicates the position of the reference line in the MRL candidate list, i.e., the n^{th} spot of the reference line in the list. In this case, the index values of the referenceable N reference lines range from 0 to N−1.

The definitions of intra_luma_ref_idx and mrl_idx used in the present disclosure are as follows.

The reference line index, intra_luma_ref_idx is a value indicating the distance from the current block to the reference line to be indicated. intra_luma_ref_idx indicates the position of the reference line and may have a value greater than or equal to zero. For example, intra_luma_ref_idx may be expressed as the number of pixels, the number of blocks, or the like. Hereinafter, intra_luma_ref_idx indicates the number of pixels.

MRL index, mrl_idx indicates the position of the reference line to be used for prediction within the MRL candidate list. mrl_idx may have a value greater than or equal to 0.

MRL candidate list and list are used interchangeably. Additionally, the terms MRL candidate list-filling method and filling method are used interchangeably.

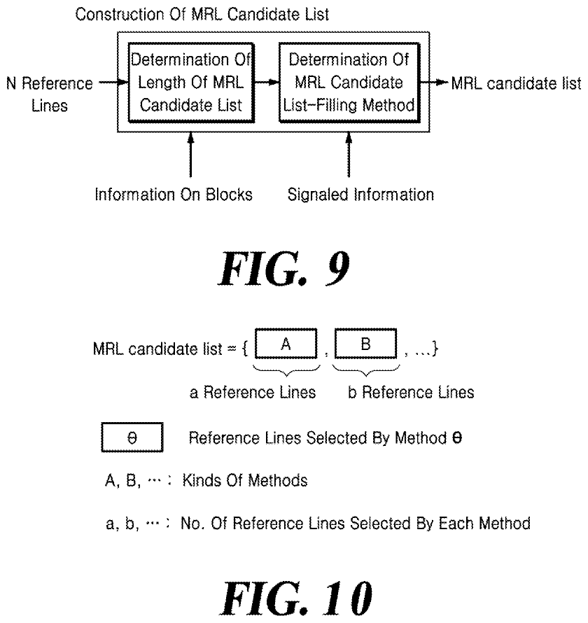

To adaptively construct the MRL candidate list, the video decoding apparatus determines the length of the MRL candidate list and an MRL candidate list-filling method. The video decoding apparatus may adaptively construct the MRL candidate list by using (Implementation 1) an MRL candidate list-filling method without predetermining the length of the list, as illustrated in FIG. 8, or it may adaptively construct the MRL candidate list by using (Implementation 2) an MRL candidate list-filling method based on a predetermined length of the list, as illustrated in FIG. 9. In this case, the length of the list indicates the number of reference lines included in the MRL candidate list. The following describes preferred embodiments for addressing the aforementioned issues.

To indicate whether to apply each of the implementations described below, the video encoding apparatus may signal, at a higher level such as a sequence parameter set (SPS), picture parameter set (PPS), or the like, sps_adaptive_mrl_candidate_list_enabled_flag, pps_adaptive_mrl_candidate_list_enabled_flag to the video decoding apparatus. While prior art MRL techniques refer to three reference lines in the VVC and six reference lines in the ECM, the present disclosure may be configured to refer to more than three reference lines (e.g., N lines).

<Implementation 1> An MRL candidate list-filling method without predetermining the length of the list.

FIG. 10 is a diagram illustrating an MRL candidate list-filling method, according to another embodiment of the present disclosure.

In this implementation, the video decoding apparatus determines an MRL candidate list-filling method without determining the length of the list in advance and then constructs the MRL candidate list of the current block according to the determined filling method. At this time, as shown in the example of FIG. 10, added to the list may be several, i.e., a, b, . . . non-duplicate reference lines selected according to each of the methods A, B, . . . , and the like. By adding or inserting the relevant reference lines to the list in a predetermined order, the video decoding apparatus may construct the MRL candidate list. The length of the MRL candidate list, i.e., the number of reference lines in the list may be determined by adding all possible additional reference lines to the list by using an MRL candidate list-filling method determined under this implementation. For example, if the list filling methods are determined to be A and B, by adding to the list all reference lines determined by these two methods, i.e., adding ‘a’ reference lines and ‘b’ reference lines, the length of the list may be determined to be ‘a+b’.

The video decoding apparatus parses the mrl_idx as information on the reference line of the current block. The video decoding apparatus determines an MRL candidate list-filling method according to the method of this implementation and constructs the MRL candidate list by using the determined filling method. The video decoding apparatus may then use the reference line indicated by mrl_idx, in the MRL candidate list to intra-predict the current block.

In this implementation, an MRL candidate list-filling method may be determined by taking into account one or more information items on blocks. The information items on blocks are as follows. Used as the distance between a block and a reference line may be the index value of the reference line, the number of pixels between the block and the reference line, the number of blocks between the block and the reference line, or the like.

Used as the information on blocks may be the features of the current block, such as its position, prediction mode, reference pixel, any predictors that can be generated, distance between an available reference line and the current block, pixel value of the available reference line, width (W), height (H), area, aspect ratio (W, H, log₂W, log₂H, log₂WH, WH, log₂ (W/H), W/H, log₂ (H/W), H/W), or the like.

Used as the information on blocks may be the features of a block located neighboring the current block in a current frame, such as the neighbor block's position, pixel values resulting from reconstructing the block, prediction mode, reference line used, whether MRL is enabled, MRL candidate list, reference pixels, any predictors that can be generated, the distance between an available reference line and the current block, the pixel values of the available reference line, the width (W), height (H), area, aspect ratio (W, H, log₂W, log₂H, log₂WH, WH, log₂ (W/H), W/H, log₂ (H/W), H/W), or the like.

Used as the information on blocks may be the features of blocks including a co-located block with the current block and a neighboring block of the co-located block in a referenceable other picture. Here, the features include the co-located and neighboring blocks' positions, pixel values resulting from reconstructing the block, prediction mode, reference line used, whether MRL is enabled, MRL candidate list, reference pixels, any predictors that can be generated, distance between an available reference line and the current block, pixel values of the available reference line, width (W), height (H), area, aspect ratio (W, H, log₂W, log₂H, log₂WH, WH, log₂ (W/H), W/H, log₂ (H/W), H/W), or the like.

Used as the information on blocks may be the features of a block reconstructed earlier than the current block, such as the reconstructed block's position, pixel values resulting from reconstructing the block, prediction mode, reference line used, whether MRL is enabled, MRL candidate list, reference pixels, any predictors that can be generated, the distance between an available reference line and the current block, pixel values of the available reference line, width (W), height (H), area, aspect ratio (W, H, log₂W, log₂H, log₂WH, WH, log₂ (W/H), W/H, log₂ (H/W), H/W), or the like.

Examples of reference lines to be used to fill up the MRL candidate list by taking into account one or more of the above-described information on blocks, and examples of the use of the above-described reference lines, are as in Method A through Method D below. In addition, any of the reference lines available to fill up the MRL candidate lists available in the current block may be used to construct the lists. Each MRL candidate list-filling method includes, in addition to the factors considered during the filling process, the order of taking into account the plurality of reference lines and the number of reference lines to fill the list. If each method cannot fill the list with reference lines by the number it has determined, such as if Method A is supposed to fill the list with three reference lines but has less than three reference lines to add, then the video decoding apparatus may stop adding reference lines by using the relevant method or may fill up the list with a predefined value until the determined number of reference lines is achieved.

Method A. Using reference lines of neighbor blocks of the current block within the current frame

In this method, the video decoding apparatus fills up the MRL candidate list of the current block with reference lines of neighbor blocks of the current block. The reference lines of the neighbor blocks may be added to the MRL candidate list in a predetermined order. When a predetermined number of different reference lines have been added to the MRL candidate list, the video decoding apparatus stops adding reference lines according to this method. In this case, the order of adding the reference lines to the list and the number of reference lines to be added may be determined to be preset values according to the relevant MRL candidate list-filling method, or they may be determined by referring to the information on blocks.

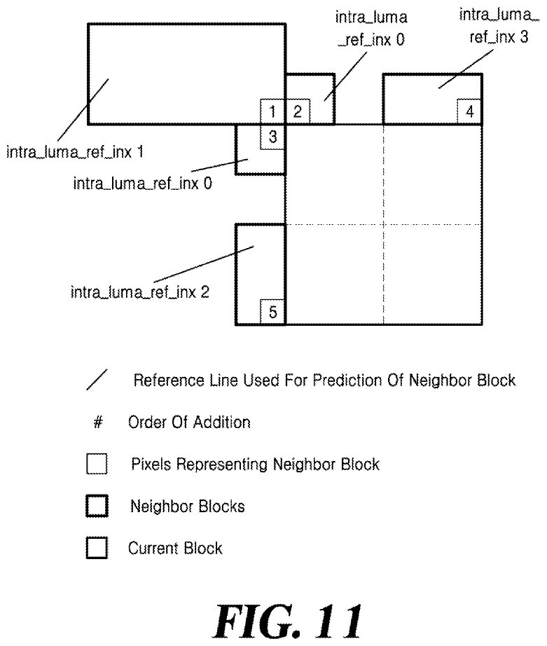

FIG. 11 is a diagram illustrating reference lines of neighbor blocks of the current block, according to at least one embodiment of the present disclosure.

One example case uses up to two reference lines to fill up the MRL candidate list, adds reference lines of the neighbor blocks to the MRL candidate list with the bigger sized reference line first, and adds reference lines to the list by using a preset order based on block position with the blocks having the same size. In the example of FIG. 11, the video decoding apparatus may add intra_luma_ref_idx 1 of block 1 to the list first, and then add intra_luma_ref_idx 3 of block 4 to the list. Since the number of reference lines to fill up the list is achieved according to this method, the video decoding apparatus does not add reference lines of other neighboring blocks to the MRL candidate list.

Another example case uses a maximum of two reference lines to fill up the MRL candidate list and adds reference lines of the neighboring blocks to the MRL candidate list with the more frequently used reference line first. In the example of FIG. 11, the video decoding apparatus first adds intra_luma_ref_idx 0 which is the only reference line used twice by the neighboring blocks, to the list. Since all other reference lines are used once, the video decoding apparatus may additionally fill the list with intra_luma_ref_idx 1 which is the reference line of block 1, taking into account the block number according to the preset position. Since the number of reference lines to fill up the list is achieved according to this method, the video decoding apparatus does not add reference lines of other neighboring blocks to the MRL candidate list.

Method B. Using reference lines according to a predetermined rule that is based on information on the current block

In this method, the video decoding apparatus fills up the MRL candidate list of the current block with reference lines according to a predetermined rule that is based on the information on the current block. The information on the current block includes the features of the current block among the above-described information on blocks. When a predetermined number of different reference lines have been added to the MRL candidate list, the video decoding apparatus stops adding reference lines according to this method. In this case, the order of adding the reference lines to the list and the number of reference lines to be added may be determined to be preset values depending on the relevant MRL candidate list-filling method, or they may be determined by referring to the information on blocks.

In one example, the video decoding apparatus may refer to the width (W) of the current block as the information on blocks to determine log₂W to be the number of reference lines to be added to the list and add reference lines having a reference line index value of W-1 or less to the list with the farther reference line from the current block first. For example, when the current block has a width of 8, the video decoding apparatus may add three reference lines to the list, in order: intra_luma_ref_idx 7, intra_luma_ref_idx 6, and intra_luma_ref_idx 5, filling up the MRL candidate list.

As another example, the video decoding apparatus may fill up the MRL candidate list by referencing distances between the current block and available reference lines as the information on blocks. When there is the number N of 8 available reference lines for the current block, the video decoding apparatus may add four reference lines to the MRL candidate list with the closer reference line to the current block first. Accordingly, the video decoding apparatus may fill up the MRL candidate list with reference lines, in order: intra_luma_ref_idx 0, intra_luma_ref_idx 1, intra_luma_ref_idx 2, and intra_luma_ref_idx 3.

As yet another example, the video decoding apparatus may fill up the MRL candidate list by referencing the predictors that are based on the available reference lines for the current block as the information on blocks. The video decoding apparatus may add the reference lines to the list in an order of generation of a different predictor than the predictor generated by intra_luma_ref_idx 0. In this case, a preset value of 2 may be determined as the number of reference lines to be added. An example case has the number N of 6 available reference lines for the current block and calculates the difference between the predictors according to SAD (Sum of Absolute Differences). The video decoding apparatus may compare the SAD between the predictor generated according to intra_luma_ref_idx 0 and the predictors generated according to the respective ones of intra_luma_ref_idx 1-5, and add the reference lines to the MRL candidate list with the reference line causing the larger difference first. In this case, a measure such as SAD, SATD (Sum of Absolute Transformed Differences), MSE (Mean Squared Error), MAE (Mean Absolute Error), or the like may be utilized as the difference between the predictors.

Further, the video decoding apparatus may refer to the pixel values of the reference lines not the predictors as the information on blocks to use an MRL candidate list-filling method based on the difference between all or some pixel values on each reference line.

FIG. 12 is a diagram illustrating the position of a current block in a coding tree unit (CTU), according to at least one embodiment of the present disclosure.

As yet another example, the video decoding apparatus may reference the position of the current block as the information on blocks. The video decoding apparatus may add the current block's reference lines that are within the current CTU to the MRL candidate list. The following case describes adding all reference lines to the list with the closer reference line to the current block first. In the example of FIG. 12, since there are three reference lines of block 1, which are currently within the CTU, the video decoding apparatus may construct the MRL candidate list of block 1 as {intra_luma_ref_idx 0, intra_luma_ref_idx 1, intra_luma_ref_idx 2}. Further, since there are currently eight reference lines of block 2, which are currently within the CTU, the video decoding apparatus may construct the MRL candidate list for block 2 as {intra_luma_ref_idx 0, intra_luma_ref_idx 1, intra_luma_ref_idx 2, . . . , intra_luma_ref_idx 6, intra_luma_ref_idx 7}.

Method C. Using reference lines of blocks reconstructed earlier than the current block

In this method, the video decoding apparatus fills up the MRL candidate list of the current block with reference lines of blocks reconstructed earlier than the current block. The reference lines of the reconstructed blocks may be added to the MRL candidate list in a predetermined order. When a predetermined number of different reference lines have been added to the MRL candidate list, the video decoding apparatus stops adding the reference lines according to this method. In this case, the order of adding the reference lines to the list and the number of reference lines to be added may be determined to be preset values depending on the relevant MRL candidate list-filling method, or they may be determined by referring to the information on blocks.

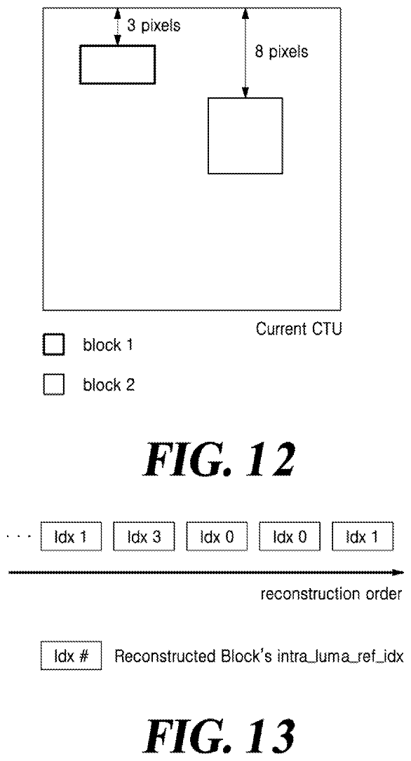

FIG. 13 is a diagram illustrating reference lines of previously reconstructed blocks, according to at least one embodiment of the present disclosure.

In one example, the reference line of the more recently reconstructed block is first added to the MRL candidate list, and the number of different reference lines further added may be determined to be 3. In the example of FIG. 13, the video decoding apparatus may add the reference lines of the more recently reconstructed blocks to the list without duplication in order: intra_luma_ref_idx 1, intra_luma_ref_idx 0, and intra_luma_ref_idx 3 to fill up the MRL candidate list. Since the number of reference lines to fill up the list is achieved according to this method, the video decoding apparatus does not add reference lines from other reconstructed blocks to the MRL candidate list.

Method D. Using reference lines of blocks including a co-located block with the current block and neighboring blocks of the co-located block in a referenceable other picture

In this method, the video decoding apparatus fills up the MRL candidate list of the current block with reference lines of blocks including a co-located block with the current block and neighboring blocks of the co-located block in a referenceable other picture. The reference lines of the co-located blocks and neighbor blocks may be added to the MRL candidate list in a predetermined order. When a predetermined number of different reference lines have been added to the MRL candidate list, the video decoding apparatus stops adding reference lines according to this method. In addition, if there is a plurality of other referenceable pictures, the video decoding apparatus may use all or some of the plurality of pictures and may determine which picture to use according to a predetermined method. In this case, the order of adding the reference lines to the list, the number of reference lines to be added, and the reference picture to be used may be determined to be preset values according to the relevant MRL candidate list-filling method, or they may be determined by referring to the information on blocks and the distance between the pictures.

In one example, the video decoding apparatus may add to the list up to three reference lines from a reference picture that is temporally farthest from the current picture. When filling up the list, the video decoding apparatus may first add reference lines of a co-located block with the current block, and then take into account the co-located block's neighboring blocks that have the same aspect ratio as that of the current block. According to the position of the ‘neighboring blocks with the same aspect ratio as the current block’, the video decoding apparatus may add the reference lines in a preset order. Then, according to the position of the ‘neighboring blocks with a different aspect ratio than the current block’, the video decoding apparatus may add the reference lines in a preset order.

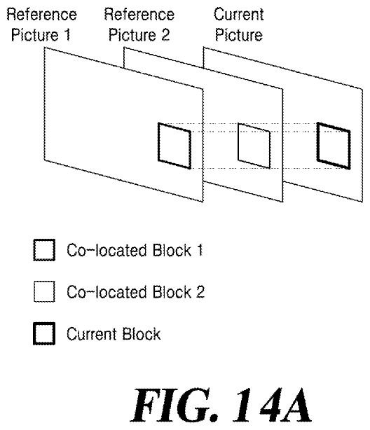

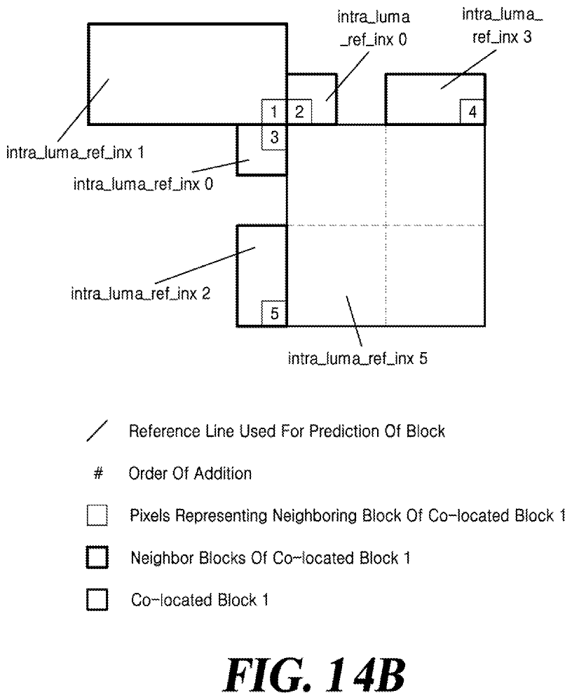

FIGS. 14A and 14B are diagrams illustrating co-located blocks in reference pictures, according to at least one embodiment of the present disclosure.

In the examples of FIGS. 14A and 14B, the video decoding apparatus first adds to the list intra_luma_ref_idx 5 which is the reference line of a co-located block 1 in the reference picture that is temporally further distant from the current picture. The video decoding apparatus then adds the reference lines of block 1's neighboring blocks 2 and 3 that have the same aspect ratio as the current block. In this case, since these two blocks have the same reference line, intra_luma_ref_idx 0 is added to the list. According to the order of block 1's neighboring blocks that have a different aspect ratio than the current block, the video decoding apparatus adds the reference line of block 1, intra_luma_ref_idx 1, to the list. The video decoding apparatus does not add reference lines from other blocks to the MRL candidate list because the number of reference lines to fill up the list is achieved according to this method.

In this implementation, the video decoding apparatus may (Implementation 1-1) be signaled the MRL candidate list-filling method, or it may (Implementation 1-2) infer the MRL candidate list-filling method based on the information on blocks.

### <Implementation 1-1> Signaling an MRL Candidate List-Filling Method

In this implementation, the video decoding apparatus parses the MRL candidate list-filling method and constructs the MRL candidate list according to the parsed filling method. At this time, one or more of Method A through Method D as described above, and other methods may be signaled.

When filling up the MRL candidate list according to one filling method, a method lookup table including the available filling methods is composed, and one filling method from the method lookup table is signaled as mrl_candidate_list_lines_select_method. Both the video decoding apparatus and the video encoding apparatus may classify the MRL candidate list-filling method according to the mrl_candidate_list_lines_select_method, and may operate according to the classified method. For example, the available MRL candidate list-filling methods may be defined as shown in Table 4.

TABLE 4

| mrl_candidate_list_lines_select_method | Method |
|---|---|
| 0 | Method A |
| 1 | Method B |
| 2 | Method C |
| . | . |
| . | . |
| . | . |

When mrl_candidate_list_lines_select_method 0 is signaled according to Table 4, the video decoding apparatus may operate according to Method A to construct the MRL candidate list with reference lines of neighbor blocks of the current block within the current frame.

When filling the MRL candidate list according to multiple filling methods, a method lookup table including the available filling methods is constructed, and the multiple filling methods based on the method lookup table are signaled as mrl_candidate_list_lines_select_method. Both the video decoding apparatus and the video encoding apparatus may classify the MRL candidate list-filling method according to the mrl_candidate_list_lines_select_method and may operate according to the classified method. When classifying the available MRL candidate list-filling method by indices, the mrl_candidate_list_lines_select_method may indicate a plurality of indices listed, or it may indicate one of multiple groups of indices. For example, the MRL candidate list-filling methods may be classified by indices, as shown in Table 5.

TABLE 5

| Index Indicative of MRL Candidate | |
|---|---|
| List-Filling Method | Method |
| 0 | Method A |
| 1 | Method B |
| 2 | Method C |
| . | . |
| . | . |
| . | . |

If two filling methods used to construct the list according to Table 5 are those indicated by index 0 and index 1, then mrl_candidate_list_lines_select_method may be signaled in the form of the two indices listed, such as ‘0 1’ or ‘1 0’. Alternatively, if multiple groups of indices exist as {0, 1}, {0, 2}, {1, 2} and the respective groups are indicated by mrl_candidate_list_lines_select_method 0, 1, 2, then mrl_candidate_list_lines_select_method may be signaled as 0.

The video decoding apparatus may determine the order of use of the multiple filling methods for filling up the MRL candidate list based on the value of mrl_candidate_list_lines_select_method, or based on the information on blocks, or set the order of use of the multiple filling methods to a preset order.

The first case is where the order of use is determined based on the value of mrl_candidate_list_lines_select_method. If the value of mrl_candidate_list_lines_select_method is signaled in the form of a plurality of indices listed, the video decoding apparatus may take into account an MRL candidate list-filling method indicated by the relevant index in the order of the indices listed. If mrl_candidate_list_lines_select_method is signaled indicating one of the multiple groups of indices, the video decoding apparatus may take into account an MRL candidate list-filling method based on the order of the indices within the relevant group. For example, if the listed indices or group of indices is signaled as ‘0 1’, the video decoding apparatus may take into account the method indicated by index 0 first, and then the method indicated by index 1.

The second case is where the order of use is determined based on the information on blocks. The video decoding apparatus determines the order of use of the multiple filling methods by referring to the information on blocks and information related to the MRL candidate list-filling method that is determined according to the information on blocks. For example, when using method A, and method B indicated by index 0 and index 1 upon receiving signal ‘0 1’, the video decoding apparatus may first use the filling method with the smaller variations of reference lines used by the referenceable blocks to fill the MRL candidate list. The following assumes the presence of neighbor blocks of the current block in the current frame, as illustrated in FIG. 11, and assumes that the current block's reference lines that fall within the current CTU are added to the MRL candidate list, as illustrated in FIG. 12. In the example of FIG. 11, there are four types of reference lines used by the referenceable blocks for the list construction according to Method A, which are intra_luma_ref_idx 0, intra_luma_ref_idx 1, intra_luma_ref_idx 2, and intra_luma_ref_idx 3. Additionally, in the example of FIG. 12, when the current block is block 1, there are three types of reference lines used by the referenceable blocks for the list construction according to Method B, which are intra_luma_ref_idx 0, intra_luma_ref_idx 1, and intra_luma_ref_idx 2. Thus, when filling up the MRL candidate list, the method B indicated by index 1 may be considered first.

The third case is where the order of use is set to a preset order. The order of use of all available MRL candidate list-filling methods may be set at a higher level, such as SPS, PPS, or the like. Alternatively, the order of use may always be a fixed order without a separate setting. In the preset order or the fixed order, the video decoding apparatus may take into account MRL candidate list-filling methods. The preset order or fixed order may be applied equally to all or some CUs. In Table 5, three methods indicated by indices 0, 1, and 2 may be available, and in that case, the preset order may be, for example, set to the order 2, 1, and 0.

The syntax elements required according to this implementation are as follows.

mrl_candidate_list_lines_select_method is a value indicating one or more of the available MRL candidate list-filling methods. The mrl_candidate_list_lines_select_method may have a single value of 0 or more or a plurality of values of 0 or more.

MRL index, mrl_idx is a value indicating the position of the reference line to be used for prediction within the MRL candidate list. mrl_idx may have a value of 0 or more.

Specific pseudocode according to this implementation may be implemented as follows. In this case, the video decoding apparatus may first parse any of the intra-prediction mode, the MRL candidate list-filling method, and the MRL index.

Parse MRL candidate list-filling method
(mrl_candidate_list_lines_select_method)
Parse reference line for use in prediction (mrl_idx)
Parse intra-prediction mode

Meanwhile, the video encoding apparatus may obtain the intra-prediction mode, the MRL candidate list-filling method, and the MRL index from a higher level, such as the SPS, the PPS, or the like. In terms of rate-distortion optimization, the higher level of the video encoding apparatus may determine the intra-prediction mode, the MRL candidate list-filling method, and the MRL index.

According to the pseudocode described above, the required syntax for transmission is shown in Table 6.

```
TABLE 6
} else {
  if( sps_mrl_enabled_flag &&
      sps_adaptive_mrl_candidate_list_enabled_flag && (
      ( y0 % CtbSizeY ) > 0 ) ) {
    mrl_candidate_list_lines_select_method
    mrl_idx
  }
  if( sps_isp_enabled_flag &&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
    intra_subpartitions_mode_flag
  if( intra_subpartitions_mode_flag = = 1 )
    intra_subpartitions_split_flag
  intra_luma_mpm_flag[ x0 ][ y0 ]
  if( intra_luma_mpm_flag[ x0 ][ y0 ] ) {
    intra_luma_not_planar_flag[ x0 ][ y0 ]
    if( intra_luma_not_planar_flag[ x0 ][ y0 ] )
      intra_luma_mpm_idx[ x0 ][ y0 ]
  } else
    intra_luma_mpm_remainder[ x0 ][ y0 ]
}
```

In Table 6, the video decoding apparatus parses the syntax elements in the order of the MRL candidate list-filling method, the reference line to be used for prediction, and the intra-prediction mode.

Meanwhile, to allow the mrl_candidate_list_lines_select_method to indicate a previously unused and new MRL candidate list-filling method, the new method may be added as an available MRL candidate list-filling method. The new method may be added both at the block level or at higher levels such as SPS and PPS. When an appropriate syntax (e.g., index) can identify a single or multiple new MRL candidate list-filling methods that are previously unused by the video decoding apparatus and the video encoding apparatus, the new MRL candidate list-filling method or methods may be further determined by a signal of the mrl_candidate_list_lines_select_method_register. Each new MRL candidate list-filling method may be added to a predefined position in the method lookup table, i.e., at one of the first, second, . . . , and last spots in the method lookup table. Alternatively, the new MRL candidate list-filling method may be added to a position in the method lookup table, which is signaled by mrl_candidate_list_lines_select_method_register_pos.

### <Implementation 1-2> Inferring MRL Candidate List-Filling Method

In this implementation, the video decoding apparatus infers an MRL candidate list-filling method and then constructs the MRL candidate list according to the inferred filling method. At this time, one or more of Method A to Method D as described above and other methods may be inferred. To infer the MRL candidate list-filling method, the video decoding apparatus may (Implementation 1-2-1) determine the MRL candidate list-filling method based on the information on blocks, or (Implementation 1-2-2) set the MRL candidate list-filling method to a preset filling method.

### <Implementation 1-2-1> Determining MRL Candidate List-Filling Method Based on the Information on Blocks

In this implementation, the video decoding apparatus determines an MRL candidate list-filling method based on the information on blocks and then constructs the MRL candidate list according to the determined filling method. At this time, one or more of the Method A to Method D as described above and other methods may be inferred.

In this implementation, when inferring an MRL candidate list-filling method, the video decoding apparatus may take into account one or more of the information on blocks. As available information on blocks, the information items on blocks described in Implementation 1 may be used. In this case, the distance between a block and a reference line may be the index value of the reference line, the number of pixels between the block and the reference line, the number of blocks between the block and the reference line, or the like. In addition, information on the MRL candidate list may be used, which includes any information about the MRL candidate list construction, such as the list-filling method used, the length of the list, and the like.

An example of inferring the MRL candidate list-filling method by taking into account one or more of the information on blocks is as follows. By taking into account reference lines of neighbor blocks of the current block within the current frame, two or more neighbor blocks may use the same reference line, and in that case, the video decoding apparatus may fill up the list according to Method A described in Implementation 1. If two blocks use intra_luma_ref_idx 0, as illustrated in the example of FIG. 11, the video decoding apparatus may construct the MRL candidate list according to Method A. Further, the video decoding apparatus may use the relevant MRL candidate list-filling method to add up to two additional reference lines to the MRL candidate list. In this case, the video decoding apparatus may fill up the list with reference lines of the neighbor blocks orderly beginning with the most frequently used reference line. If the reference lines have the same frequency of use, the video decoding apparatus may add the reference lines to the list in an order based on the position of the block. For the example in FIG. 11, the video decoding apparatus adds intra_luma_ref_idx 0 to the list first because it is the only reference line used twice by the neighbor blocks. Since all other reference lines are used once, the video decoding apparatus may add intra_luma_ref_idx 1, the reference line of block 1, to the list next, taking into account the block number. Since the number of reference lines to fill up the list is achieved according to this method, the video decoding apparatus does not add reference lines of other neighboring blocks to the MRL candidate list.

If multiple filling methods are inferred to construct the MRL candidate list, the video decoding apparatus may fill the list by using the inferred multiple filling methods. In doing so, the order of considering the multiple filling methods needs to be further determined. The video decoding apparatus may determine the order of use of the multiple filling methods based on the information on blocks. Alternatively, if there is a method lookup table that classifies the multiple filling methods by indices, the video decoding apparatus may determine the order of use in an ascending/descending/random order based on the value of the index.

The first case is where the order of use is determined based on the information on blocks. The video decoding apparatus determines the order of use of the multiple filling methods by referring to the information on blocks and information related to the inferred MRL candidate list-filling method. An example assumes that to construct the MRL candidate list, Method A is used to add two reference lines to the list with the more frequently used reference line first, or if the frequency of use is equal, add them in order based on the position of the block, or Method C is used to add three reference lines to the list with the reference line of the more recently reconstructed block added first. The order of use of the two methods may be determined by the smaller number of reference lines added by each method. Namely, two reference lines are added by Method A and three reference lines by Method C, so the video decoding apparatus may use Method A first to fill up the list. Alternatively, the more the similarity between the reference lines of the blocks considered in each method are to each other, the higher priority may be given to that method. An example assumes that the current block's neighbor blocks used in Method A all have different reference lines, and the previously reconstructed blocks' reference lines used in Method C are {1, 1, 1, 2, 1, 0, 3, 3, . . . } when listed in order of most recently reconstructed. Since the blocks' reference lines identified in method C have greater similarity, the video decoding apparatus may fill up the list by using Method C first.

The second case is where the order of use is determined by indices that classify the multiple filling methods. When multiple MRL candidate list-filling methods are inferred and each filling method is classified by an index, the video decoding apparatus may take into account using each MRL candidate list-filling method according to the index. In this case, the order (ascending/descending/random order of the index) that takes into account all available MRL candidate list-filling methods classified by the indices may be set at a higher level, such as SPS, PPS, or the like. Alternatively, the order of use may always be a fixed order without a separate setting. In the preset order and the fixed order, the video decoding apparatus may take into account an MRL candidate list-filling method. The preset order or fixed order may be applied equally to all or some CUs. In Table 5, three methods indicated by indices 0, 1, and 2 may be available, and in that case, the preset order may be, for example, set to the order 2, 1, and 0.

### <Implementation 1-2-2> Setting MRL Candidate List-Filling Method to Preset Filling Method

In this implementation, the video decoding apparatus sets the MRL candidate list-filling method to a preset filling method, and then constructs the MRL candidate list according to the preset filling method. At this time, one or more of Method A to Method D as described above and other methods may be set. The MRL candidate list-filling method may be set at a higher level, such as SPS, PPS, or the like. Alternatively, the MRL candidate list-filling method may be a constantly fixed method without a separate setting. The preset or fixed method may be applied equally to all or some CUs.

When multiple filling methods are preset for constructing the MRL candidate list, there is a need to further determine the order of considering the preset multiple filling methods. The video decoding apparatus may determine the order of use of the multiple filling methods based on the information on blocks. Alternatively, if there is a method lookup table that classifies the multiple filling methods by indices, the video decoding apparatus may determine the order of use in ascending/descending/random order according to the value of the index. The order of considering the multiple filling methods according to this implementation is dependent on Implementation 1-2-1 and is therefore omitted from further description.

### <Implementation 2> MRL Candidate List-Filling Method Based on the Predetermined Length of the List

In this implementation, the video decoding apparatus constructs the MRL candidate list of the current block according to a predetermined length of the MRL candidate list, i.e., the number of reference lines included in the MRL candidate list. As illustrated in FIG. 9, the video decoding apparatus sequentially performs ‘determining the length of the MRL candidate list’ and ‘determining an MRL candidate list-filling method’ and fills the list with reference lines as long as the determined length of the list. Since the MRL candidate list-filling method may be implemented the same as in Implementation 1, the following implementation describes the determination of the length of the MRL candidate list.

In this implementation, the video decoding apparatus may (Implementation 2-1) be signaled the length of the MRL candidate list or it may (Implementation 2-2) infer the length of the MRL candidate list based on the information on blocks. If using the method of Implementation 1 is not sufficient to fill up the list by the length determined in this implementation, the video decoding apparatus may use a predetermined method to add reference lines to the list that are not duplicates of reference lines already included. The predetermined method may include, among other methods implementable according to Implementation 1, an unselected MRL candidate list-filling method, a method of filling the list with predefined reference lines, and the like.

The video decoding apparatus parses the mrl_idx as information on the reference line of the current block. When performing intra prediction on the current block, the video decoding apparatus determines a list length and a list-filling method according to the present disclosure and then constructs an MRL candidate list by using the determined list length and the list-filling method. The video decoding apparatus may derive from the MRL candidate list a reference line indicated by mrl_idx, and use the derived reference line for intra-predicting the current block.

### <Implementation 2-1> Signaling the Length of the MRL Candidate List

In this implementation, the video decoding apparatus parses the length of the MRL candidate list. The video encoding apparatus signals mrl_candidate_list_len, which indicates the length of the MRL candidate list, to the video decoding apparatus. In some embodiments, mrl_candidate_list_len may directly represent a length value (x) or may represent the resultant value after applying a predetermined operation (f(x)) to the length value (x). Alternatively, when provided with a length lookup table containing usable values for the length of the MRL candidate list, mrl_candidate_list_len may be an index indicating one of the values contained in the length lookup table. The following describes each of the definitions for mrl_candidate_list_len.

First, mrl_candidate_list_len indicates none other than the length value of the MRL candidate list. For example, if the length of the MRL candidate list is determined to be 6, i.e., there are six reference lines in the MRL candidate list, mrl_candidate_list_len may be signaled as 6.

Second, mrl_candidate_list_len indicates the resultant value after applying a predetermined operation (f(x)) to a length value (x) of the MRL candidate list. For example, if the length of the MRL candidate list is determined to be 6, i.e., there are 6 reference lines in the MRL candidate list, mrl_candidate_list_len may be signaled as 2 by applying the operation ‘f(x)=x/3’.

Third, mrl_candidate_list_len may be an index that indicates one of the values in the length lookup table described above. By using Table 7, an example describes the indication of one of the values contained in the length lookup table.

TABLE 7

| | Number of Reference Lines in MRL Candidate |
|---|---|
| mrl_candidate_list_len | List |
| 0 | 1 |
| 1 | 3 |
| 2 | 6 |
| . | . |
| . | . |
| . | . |

When signaled mrl_candidate_list_len 2 according to Table 7, the video decoding apparatus may determine the length of the MRL candidate list to be 6.

The syntax elements required according to this implementation are as follows.

mrl_candidate_list_len indicates the length of the MRL candidate list. In some embodiments, mrl_candidate_list_len may be a length value, the resultant value after applying a predetermined operation to the length value, an index indicating one of the usable values in the length lookup table, or the like.

The MRL index mrl_idx is a value indicating the position of the reference line to be used for prediction within the MRL candidate list. mrl_idx may have a value greater than or equal to 0.

Specific pseudocode according to this implementation may be implemented as follows. The video decoding apparatus may first parse any of the following: the intra-prediction mode, the length of the MRL candidate list, the MRL candidate list-filling method, and the MRL index.

Parse length of MRL candidate list (mrl_candidate_list_len)
Parse MRL candidate list-filling method
(mrl_candidate_list_lines_select_method)
Parse reference line for use in prediction (mrl_idx)
Parse intra-prediction mode

Meanwhile, the video encoding apparatus may obtain the intra-prediction mode, the length of the MRL candidate list, the MRL candidate list-filling method, and the MRL index from a higher level, such as the SPS, PPS, or the like. In terms of rate-distortion optimization, the higher level of the video encoding apparatus may determine the intra-prediction mode, the length of the MRL candidate list, the MRL candidate list-filling method, and the MRL index.

According to the pseudocode described above, the required syntax for transmission is shown in Table 8.

```
TABLE 8
} else {
  if( sps_mrl_enabled_flag &&
        sps_adaptive_mrl_candidate_list_enabled_flag && (
        ( y0 % CtbSizeY ) > 0 ) ) {
    mrl_candidate_list_len
    mrl_candidate_list_lines_select_method
    mrl_idx
  }
  if( sps_isp_enabled_flag &&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
    intra_subpartitions_mode_flag
  if( intra_subpartitions_mode_flag = = 1 )
    intra_subpartitions_split_flag
  intra_luma_mpm_flag[ x0 ][ y0 ]
  if( intra_luma_mpm_flag[ x0 ][ y0 ] ) {
    intra_luma_not_planar_flag[ x0 ][ y0 ]
    if( intra_luma_not_planar_flag[ x0 ][ y0 ] )
      intra_luma_mpm_idx[ x0 ][ y0 ]
  } else
    intra_luma_mpm_remainder[ x0 ][ y0 ]
}
```

In Table 8, the video decoding apparatus parses the syntax elements in the order of the length of the MRL candidate list, the MRL candidate list-filling method, the reference line to be used for prediction, and the intra-prediction mode.

When indicating a value in the length lookup table with an index, new lengths that are absent from the existing length lookup table may be added to the length lookup table to allow mrl_candidate_list_len to indicate the new lengths. The new lengths may be added both at the block level or at higher levels such as SPS and PPS. The length values being added may be signaled with mrl_candidate_list_len_register. Each new length may be added to a predefined position in the length lookup table, i.e., at one of the first, second, . . . , or last spots in the length lookup table. Alternatively, the new length may be added to a position in the length lookup table, which is signaled by mrl_candidate_list_len_register_pos.

### <Implementation 2-2> Inferring the Length of the MRL Candidate List

In this implementation, the video decoding apparatus infers the length of the MRL candidate list. To infer the length of the MRL candidate list, the video decoding apparatus may (Implementation 2-2-1) determine the length of the MRL candidate list based on the information on blocks or (Implementation 2-2-2-) set the length of the MRL candidate list to a preset value.

### <Implementation 2-2-1> Determining the Length of the MRL Candidate List Based on the Information on Blocks

In this implementation, the video decoding apparatus determines the length of the MRL candidate list based on the information on blocks.

In this implementation, when inferring the length of the MRL candidate list, the video decoding apparatus may take into account one or more of the information on blocks. As available information on blocks, the information items on blocks described in Implementation 1 may be used. In this case, the distance between a block and a reference line may be the index value of the reference line, the number of pixels between the block and the reference line, the number of blocks between the block and the reference line, or the like. In addition, information on the MRL candidate list may be used, which includes the MRL candidate list used, the length of the MRL candidate list used, and the like.

The following describes examples of determining the length of the MRL candidate list by referring to the information on blocks.

In one example, when referring to the current block's width (log₂WH) as the information on blocks, the length of the MRL candidate list may be determined based on the width of the current block, as shown in Table 9.

TABLE 9

| | Length of MRL Candidate |
|---|---|
| Block size (log₂ WH) | List |
| Block size < 8 | 3 |
| Block size ≥ 8 | 6 |

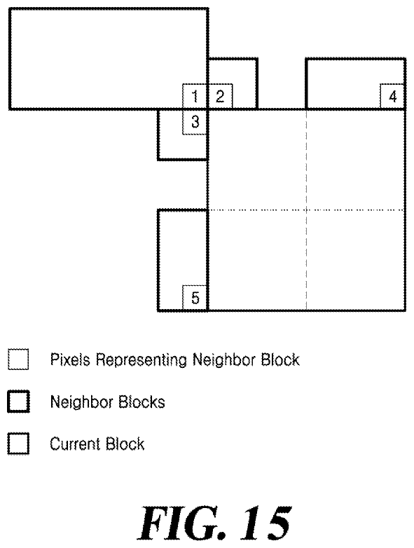

As another example, when referring to the reference line used by neighbor blocks as the information on blocks, the length of the MRL candidate list may be determined by the difference in neighboring blocks' reference lines, i.e., the different numbers of reference line types used by neighbor blocks. An example assumes, as shown in the example in FIG. 15, that among the neighbor blocks that include pixels 1 through 5 adjacent to the current block, blocks 1, 2, and 3 use intra_luma_ref_idx 0 for prediction, and blocks 4 and 5 use intra_luma_ref_idx 2 for prediction. In the example of FIG. 15, since the neighboring blocks use two reference line types for prediction, the length of the current block's MRL candidate list may be determined to be 2.

Another example refers to, in place of the information on blocks, the prediction mode of the current block, the pixel values of the respective reference lines, and the current block's predictor generated with each reference line. The video decoding apparatus uses the available reference lines to generate predictors of the current block and then calculates SADs between the generated predictors. If at least one of the values of the SADs, the mean value of the SADs, the median value of the SADs, or the maximum value of the SADs is smaller than a preset threshold, the video decoding apparatus may set the length of the MRL candidate list to a small value. On the other hand, if the values of the SADs, the mean value of the SADs, the median value of the SADs, the maximum value of the SADs, and the like are all greater than or equal to the preset threshold, the video decoding apparatus may set the length of the MRL candidate list to a large value. For example, the length of the MRL candidate list may be determined according to the maximum value of the SADs between the predictors described above, as shown in Table 10. According to Table 10, if the maximum value of the SAD is less than 100, the video decoding apparatus may determine the length of the MRL candidate list to be 3. On the other hand, if the SAD maximum value is greater than or equal to 100, the video decoding apparatus may determine the length of the MRL candidate list to be 6.

TABLE 10

| | Length of MRL Candidate |
|---|---|
| Maximum SAD Between Predictors | List |
| Maximum SAD < 100 | 3 |
| Maximum SAD ≥ 100 | 6 |

### <Implementation 2-2-2> Setting the Length of the MRL Candidate List to a Preset Value

In this implementation, the video decoding apparatus sets the length of the MRL candidate list to a preset value. The length of the MRL candidate list may be set at a higher level, such as SPS, PPS, or the like. Alternatively, the length of the MRL candidate list may always be a fixed value without a separate setting. The preset or fixed value may be applied equally to all or some CUs.

### <Implementation 3> Selectively Using Prior Art and Implementations 1 and 2

In this implementation, to selectively apply the prior art and the above-described Implementations 1 and 2, the video decoding apparatus may parse additional signals. The video encoding apparatus may send an adaptive_mrl_candidate_list_flag to indicate information on the reference line to be used for predicting the current block. For example, as shown in Table 11, if adaptive_mrl_candidate_list_flag is 0, the video decoding apparatus uses the conventional technique of a fixed MRL candidate list. On the other hand, if adaptive_mrl_candidate_list_flag is 1, the video decoding apparatus can generate an MRL candidate list according to Implementation 1.

TABLE 11

| | | |
|---|---|---|
| adaptive_mrl_candidate_list_flag | 0 | Use existing technique |
| | 1 | Use Implementation 1 |

As another example, if adaptive_mrl_candidate_list_flag is 1, as shown in Table 12, the video decoding apparatus may further parse adaptive_mrl_candidate_list_idx and select one of Implementations 1 and 2 based on the parsed index. The video decoding apparatus may then generate an MRL candidate list based on the selected technique.

TABLE 12

| adaptive_mrl_candidate_{—} | 0 | Use existing technique | | |
|---|---|---|---|---|
| list_flag | 1 | adaptive_mrl_candidate_{—} | 0 | Use Implementation 1 |
| | | list_idx | 1 | Use Implementation 2 |
| | | | . | . |
| | | | . | . |
| | | | . | . |

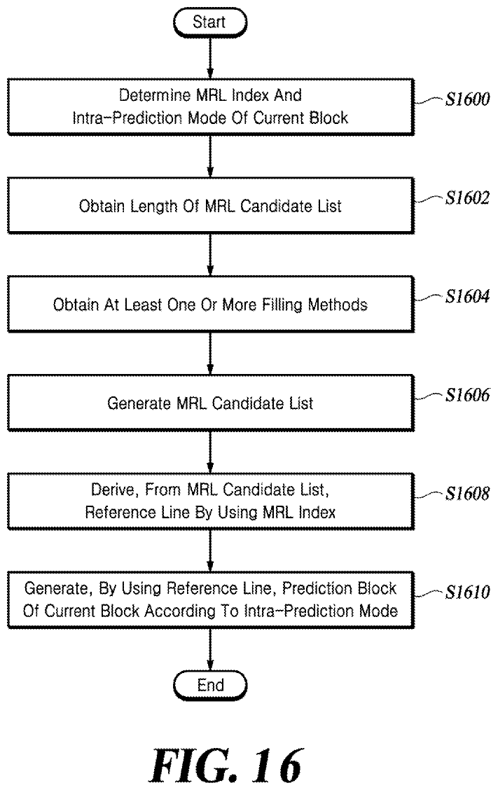

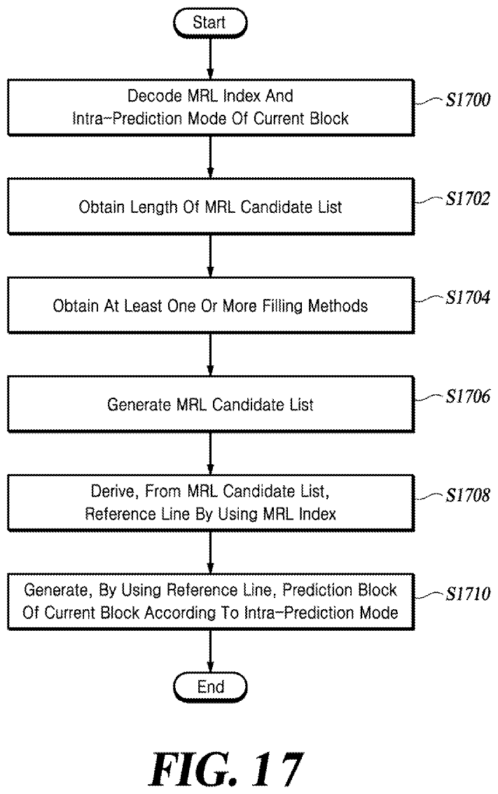

Hereinafter, with reference to FIGS. 16 and 17, methods of adaptively determining the length of an MRL candidate list and an MRL candidate list-filling method are described.

FIG. 16 is a flowchart of a method of encoding the current block by the video encoding apparatus, according to at least one embodiment of the present disclosure.

The video encoding apparatus determines an MRL index and an intra-prediction mode of the current block (S1600). Here, the MRL index indicates a reference line to use for intra-prediction of the current block within the MRL candidate list. In terms of rate-distortion optimization, the video encoding apparatus may determine the intra-prediction mode and the MRL index.

The video encoding apparatus obtains the length of the MRL candidate list (S1602). Here, the length of the MRL candidate list indicates the number of reference lines included in the MRL candidate list.

In one example, the video encoding apparatus may determine the length of the MRL candidate list in terms of rate-distortion optimization. The video encoding apparatus encodes the determined length of the MRL candidate list.

As another example, the video encoding apparatus may determine the length of the MRL candidate list based on the information on blocks or may set the length of the MRL candidate list to a preset value.

The video encoding apparatus obtains at least one or more filling methods for filling up the MRL candidate list (S1604).

In one example, the video encoding apparatus may determine at least one or more filling methods in terms of rate-distortion optimization. The video encoding apparatus encodes an index indicative of at least one or more filling methods determined among the filling methods included in the preset method lookup table.

As another example, the video encoding apparatus may determine at least one or more filling methods based on the information on blocks or may set at least one or more filling methods to a preset filling method.

The video encoding apparatus generates the MRL candidate list by adding reference lines corresponding to the MRL candidate list's length to the MRL candidate list by using at least one or more filling methods (S1606).

The video encoding apparatus derives a reference line from the MRL candidate list by using the MRL index (S1608).

The video encoding apparatus uses the reference line to generate a prediction block of the current block according to the intra-prediction mode (S1610).

The video encoding apparatus may then subtract the prediction block from the original block of the current block to generate a residual block, and encode the residual block.

FIG. 17 is a flowchart of a method of reconstructing the current block by the video decoding apparatus, according to at least one embodiment of the present disclosure.

The video decoding apparatus decodes, from the bitstream, an MRL index and an intra-prediction mode of the current block (S1700). Here, the MRL index indicates a reference line within the MRL candidate list, to be used for intra-prediction of the current block.

The video decoding apparatus obtains the length of the MRL candidate list (S1702). Here, the length of the MRL candidate list indicates the number of reference lines included in the MRL candidate list.

In one example, the video decoding apparatus decodes the length of the MRL candidate list from the bitstream.

As another example, the video decoding apparatus may determine the length of the MRL candidate list based on the information on blocks, or may set the length of the MRL candidate list to a preset value.

The video decoding apparatus obtains at least one or more filling methods for filling up the MRL candidate list (S1704).

In one example, the video decoding apparatus decodes from the bitstream an index indicative of at least one or more filling methods among the filling methods included in a preset method lookup table.

As another example, the video decoding apparatus may determine at least one or more filling methods based on the information on blocks, or may set at least one or more filling methods to the preset filling method.

By using the at least one or more filling methods, the video decoding apparatus generates the MRL candidate list by adding reference lines corresponding to the MRL candidate list's length to the MRL candidate list (S1706).

The video decoding apparatus derives a reference line from the MRL candidate list by using the MRL index (S1708).

The video decoding apparatus uses the reference line to generate a prediction block of the current block according to the intra-prediction mode (S1710).

The video decoding apparatus may then decode a residual block from the bitstream, and sum the residual block and the prediction block to generate a reconstructed block of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

122: intra predictor
155: entropy encoder
510: entropy decoder
542: intra predictor

### CROSS-REFERENCE TO RELATED APPLICATIONS

This application claims priority to and the benefit of Korean Patent Application No. 10-2022-0179526 filed on Dec. 20, 2022, and Korean Patent Application No. 10-2023-0159458, filed on Nov. 16, 2023, the entire contents of each of which are incorporated herein by reference.

1. A method of reconstructing a current block by a video decoding apparatus, the method comprising:
decoding, from a bitstream, an intra-prediction mode of the current block and a multiple reference line index (MRL index) that indicates, from within an MRL candidate list, a reference line to be used for intra prediction of the current block;
obtaining a length of the MRL candidate list, the length of the MRL candidate list indicating a number of reference lines included in the MRL candidate list;
obtaining at least one or more filling methods;
generating the MRL candidate list by adding reference lines corresponding to the length of the MRL candidate list to the MRL candidate list by using the at least one or more filling methods;
deriving the reference line from the MRL candidate list by using the MRL index; and
generating, by using the reference line, a prediction block of the current block according to the intra-prediction mode.

2. The method of claim 1, wherein obtaining the at least one or more filling methods comprises:
decoding, from the bitstream, an index indicative of the at least one or more filling methods among filling methods included in a predefined method lookup table.

3. The method of claim 2, wherein generating the MRL candidate list comprises, when the at least one or more filling methods are multiple filling methods:
determining a usage order of the multiple filling methods based on a value of the index, or determining the usage order based on information on blocks, or setting the usage order to a preset order,
wherein the information on blocks comprises:
features of the current block, features of a block located neighboring the current block in a current frame, features of a block reconstructed earlier than the current block, or features of blocks including a co-located block with the current block and a neighboring block of the co-located block in a referenceable other picture.

4. The method of claim 1, wherein obtaining the at least one or more filling methods comprises:
determining the at least one or more filling methods based on information on blocks, or setting the at least one or more filling methods to a preset method,
wherein the information on blocks comprises:
features of the current block, features of a block located neighboring the current block in a current frame, features of a block reconstructed earlier than the current block, or features of blocks including a co-located block with the current block and a neighboring block of the co-located block in a referenceable other picture.

5. The method of claim 4, wherein generating the MRL candidate list comprises, when the at least one or more filling methods are multiple filling methods:
determining a usage order of the multiple filling methods based on the information on blocks, or setting the usage order to a preset order.

6. The method of claim 1, wherein the at least one or more filling methods each comprise:
a method of using reference lines of neighboring blocks of the current block in a current frame, a method of using reference lines according to a predetermined rule based on features of the current block, a method of using reference lines of a block reconstructed earlier than the current block, or a method of using reference lines of blocks including a co-located block with the current block and neighbor blocks of the co-located block in a referenceable other picture.

7. The method of claim 1, wherein obtaining the length of the MRL candidate list comprises:
decoding the length of MRL candidate list from the bitstream.

8. The method of claim 7, wherein decoding the length of MRL candidate list comprises:
decoding an unaltered value of the length of the MRL candidate list, decoding, for the length of MRL candidate list, a value obtained by applying a predetermined function to the length of the MRL candidate list, or decoding, for the length of MRL candidate list, an index indicative of one of values contained in a predefined length lookup table.

9. The method of claim 1, wherein obtaining the length of the MRL candidate list comprises:
determining the length of the MRL candidate list based on information on blocks, or setting the length of the MRL candidate list to a preset value,
wherein the information on blocks comprises:
features of the current block, features of a block located neighboring the current block in a current frame, features of a block reconstructed earlier than the current block, or features of blocks including a co-located block with the current block and a neighboring block of the co-located block in a referenceable other picture.

10. A method of encoding a current block by a video encoding apparatus, the method comprising:
determining an intra-prediction mode of the current block and a multiple reference line index (MRL index) that indicates, from within an MRL candidate list, a reference line to be used for intra prediction of the current block;
obtaining a length of the MRL candidate list, the length of the MRL candidate list indicating a number of reference lines included in the MRL candidate list;
obtaining at least one or more filling methods;
generating the MRL candidate list by adding reference lines corresponding to the length of the MRL candidate list to the MRL candidate list by using the at least one or more filling methods;
deriving the reference line from the MRL candidate list by using the MRL index; and
generating, by using the reference line, a prediction block of the current block according to the intra-prediction mode.

11. The method of claim 10, wherein obtaining the at least one or more filling methods comprises:
obtaining, from a higher level, an index indicative of the at least one or more filling methods among filling methods included in a predefined method lookup table.

12. The method of claim 11, further comprising:
encoding the index.

13. The method of claim 10, wherein obtaining the at least one or more filling methods comprises:
determining the at least one or more filling methods based on information on blocks, or setting the at least one or more filling methods to a preset method,
wherein the information on blocks comprises:
features of the current block, features of a block located neighboring the current block in a current frame, features of a block reconstructed earlier than the current block, or features of blocks including a co-located block with the current block and a neighboring block of the co-located block in a referenceable other picture.

14. The method of claim 10, wherein obtaining the length of the MRL candidate list comprises:
obtaining the length of the MRL candidate list from a higher level.

15. The method of claim 14, further comprising:
encoding the length of the MRL candidate list.

16. The method of claim 11, wherein obtaining the length of the MRL candidate list comprises:
determining the length of the MRL candidate list based on information on blocks, or setting the length of the MRL candidate list to a preset value,
wherein the information on blocks comprises:
features of the current block, features of a block located neighboring the current block in a current frame, features of a block reconstructed earlier than the current block, or features of blocks including a co-located block with the current block and a neighboring block of the co-located block in a referenceable other picture at a co-location.

17. A computer-readable recording medium storing a bitstream generated by a video encoding method, the video encoding method comprises:
determining an intra-prediction mode of a current block and a multiple reference line index (MRL index) that indicates, from within an MRL candidate list, a reference line to be used for intra prediction of the current block;
obtaining a length of the MRL candidate list, the length of the MRL candidate list indicating a number of reference lines included in the MRL candidate list;
obtaining at least one or more filling methods;
generating the MRL candidate list by adding reference lines corresponding to the length of the MRL candidate list to the MRL candidate list by using the at least one or more filling methods;
deriving the reference line from the MRL candidate list by using the MRL index; and
generating, by using the reference line, a prediction block of the current block according to the intra-prediction mode.
